(19) United States
(12) Patent Application Publication
(10) Pub. No.: US 2026/0192325 A1
(43) Pub. Date: Jul. 9, 2026

(54) CAULKING GUN

(71) Applicant: SIANG SYUAN FU ENTERPRISE CO., LTD., Changhua County (TW)

(72) Inventor: Chen-Hsuan HUNG, Changhua County (TW)

(21) Appl. No.: 19/011,913

(22) Filed: Jan. 7, 2025

(51) Int. Cl. B05C 17/01

(52) U.S. Cl. CPC B05C 17/0123

(57) ABSTRACT

A caulking gun includes a gun body, a push rod, a driving member, a lever and a pivot mechanism. The push rod and the driving member are movably disposed on the gun body, and the driving member drives the push rod to move. The lever is swingably disposed on the gun body and includes an abutting portion being abuttable against the driving member. The pivot mechanism includes a pivoting member connected with the lever and the gun body and at least one restricting member disposed on the gun body. The pivoting member includes a first pivot portion and a second pivot portion, and a position of the at least one restricting member is adjustable relative to the pivoting member so that one of the first pivot portion and the second pivot portion serves as a pivot axis, and the lever is pivotable about the pivot axis.

### BACKGROUND OF THE INVENTION

### FIELD OF THE INVENTION

The present invention relates to a caulking gun.

### DESCRIPTION OF THE PRIOR ART

A caulking gun is configured to caulk gaps at a corner or between gapped objects. A conventional caulking gun includes a gun body, a push rod movably disposed on the gun body, a driving member frictionally driving the push rod, and a lever which is abuttable against the driving member. For various requirements, the conventional caulking gun controls a squeezing amount of the caulking material by restricting a swinging range of the lever or pushing the driving member in different position. However, an adjusting mechanism of the conventional caulking gun is complicated in structure, making it inconvenient to manufacture and adjust. Moreover, it cannot accurately control the amount of caulking material squeezed.

The present invention is, therefore, arisen to obviate or at least mitigate the above-mentioned disadvantages.

### SUMMARY OF THE INVENTION

The main object of the present invention is to provide a caulking gun, a pivot axis of a lever of the caulking gun is changeable , and the caulking gun has a simple structure and is easy to be assembled.

To achieve the above and other objects, the present invention provides a caulking gun, including: a gun body, a push rod, a driving member, a lever and a pivot mechanism. The push rod is movably disposed on the gun body. The driving member is movably disposed on the gun body and drives the push rod to move. The lever is swingably disposed on the gun body and includes an abutting portion being abuttable against the driving member. The pivot mechanism includes a pivoting member connected with the lever and the gun body and at least one restricting member disposed on the gun body, and the pivoting member includes a first pivot portion and a second pivot portion. A position of the at least one restricting member is adjustable relative to the pivoting member so that one of the first pivot portion and the second pivot portion serves as a pivot axis, and the lever is pivotable about the pivot axis.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a breakdown drawing of a gun body and a main body according to a preferable embodiment of the present invention;

FIGS. 4 and 5 are drawings showing operation according to a preferable embodiment of the present invention when a restricting member is in a first position;

FIG. 6 is an enlargement of FIG. 4; and

FIGS. 7 and 8 are drawings showing operation according to a preferable embodiment of the present invention when the restricting member is in a second position

### DETAILED DESCRIPTION OF THE PREFERRED EMBODIMENTS

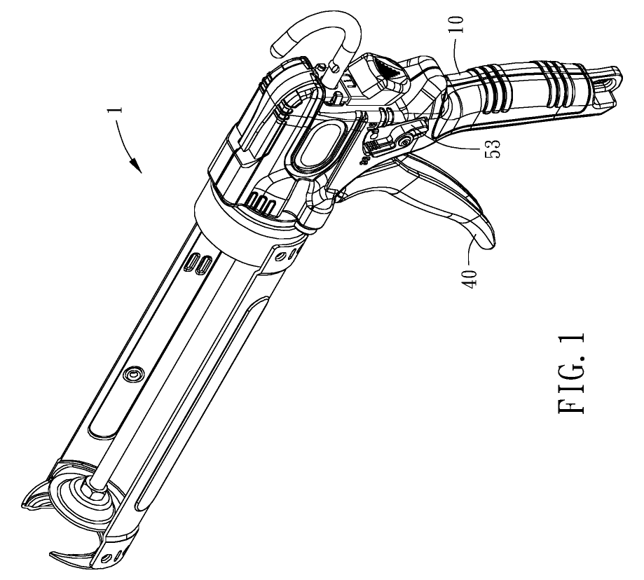

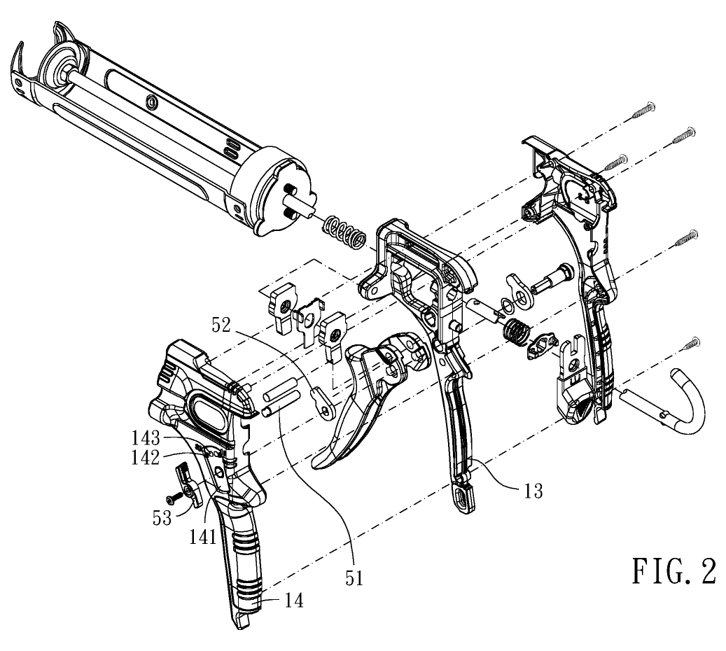

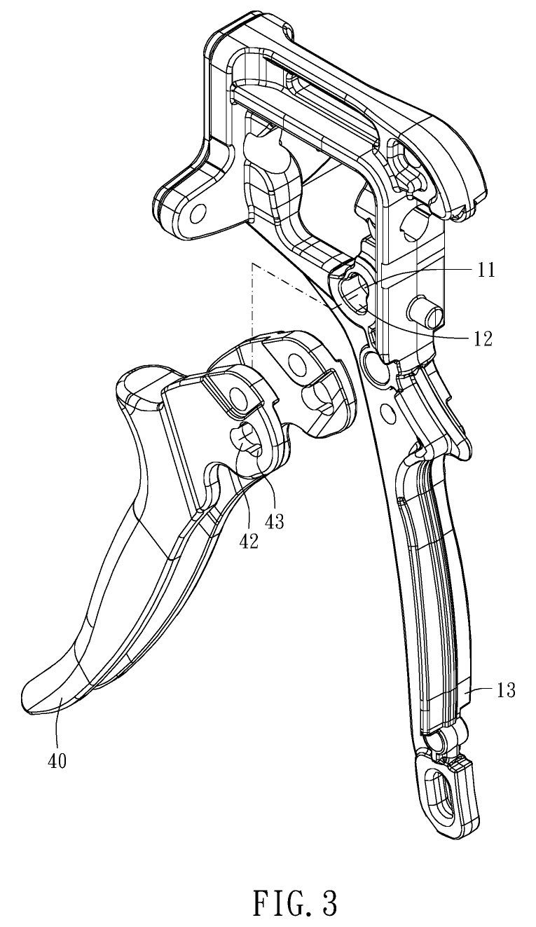

Please refer to FIGS. 1 to 8 for a preferable embodiment of the present invention. A caulking gun 1 of the present invention includes a gun body 10, a push rod 20, a driving member 30, a lever 40 and a pivot mechanism 50.

The push rod 20 is movably disposed on the gun body 10. The driving member 30 is movably disposed on the gun body 10 and drives the push rod 20 to move. The lever 40 is swingably disposed on the gun body 10 and includes an abutting portion 41 being abuttable against the driving member 30. The pivot mechanism 50 includes a pivoting member 51 connected with the lever 40 and the gun body 10 and at least one restricting member 52 disposed on the gun body 10, and the pivoting member 51 includes a first pivot portion 511 and a second pivot portion 512. A position of the at least one restricting member 52 is adjustable relative to the pivoting member 51 so that one of the first pivot portion 511 and the second pivot portion 512 serves as a pivot axis C, and the lever 40 is pivotable about the pivot axis C. Therefore, a distance that the abutting portion 41 pushes the driving member 30 and/ or a force that the abutting portion 41 exerted on the driving member 30 when the lever 40 is actuated is adjustable.

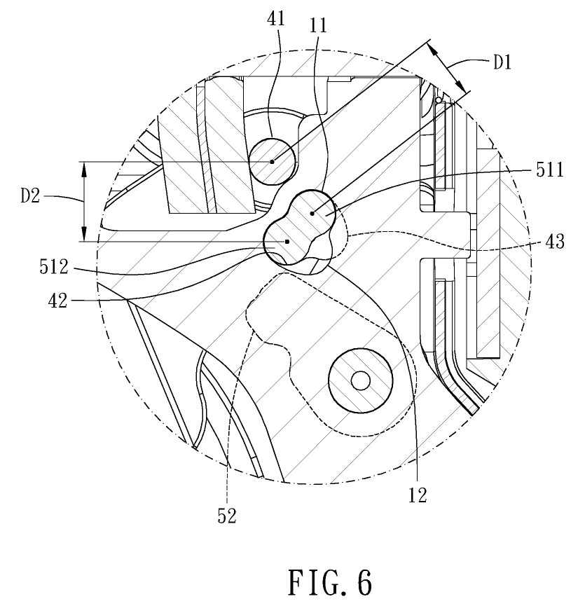

Specifically, the pivoting member 51 is integrally formed in one piece, and a cross section of the pivoting member 51 is formed in a shape of two partially overlapping circles. The pivoting member 51 is preferably made of metal, which has a simple structure, good structural strength, and is easy to be assembled. Moreover, the gun body 10 has a first pivot groove 11 and a first swinging groove 12 communicated with each other, the first pivot portion 511 is located within the first pivot groove 11, and the second pivot portion 512 is movable within the first swinging groove 12. The lever 40 has at least one second pivot groove 42 and at least one second swinging groove 43 communicated with each other, the second pivot portion 512 is located within the at least one second pivot groove 42, and the first pivot portion 511 is movable within the at least one second swinging groove 43. The first pivot groove 11 is overlapped with the at least one second swinging groove 43, and the at least one second pivot groove 42 is overlapped with the first swinging groove 12, as shown in FIG. 6. A radial profile of the first pivot groove 11 corresponds to a radial profile of the first pivot portion 511, and an extension length of the first swinging groove 12 is greater than a diametrical dimension of the second pivot portion 512. A radial profile of each said second pivot groove 42 corresponds to a radial profile of the second pivot portion 512, and an extension length of each said second swinging groove 43 is greater than a diametrical dimension of the first pivot portion 511, which allows the lever 40 to stably and smoothly swing about the first pivot portion 511 or the second pivot portion 512. In addition, compare to an existing caulking gun, structures of the gun body 10 and the lever 40 are simplified, which is easy to be processed and assembled, and the caulking gun 1 has less parts and a compact structure.

In operation, the at least one restricting member 52 is rotatably disposed on the gun body 10 and movable relative to the pivoting member 51 between a first position and a second position. When the at least one restricting member 52 is in the first position, the at least one restricting member 52 is free of interference with the pivoting member 51, and the first pivot portion 511 serves as the pivot axis C about which the lever 40 pivots. When the at least one restricting member 52 is in the second position, the at least one restricting member 52 is interfered with the pivoting member 51, and the second pivot portion 512 serves as the pivot axis C about which the lever 40 pivots. In this embodiment, each said restricting member 52 is a metal plate, which has a simple structure, good structural strength and is easy to manufacture. In other embodiments, each said restricting member may be made of a plastic material; each said restricting member may be mounted to the gun body in other ways.

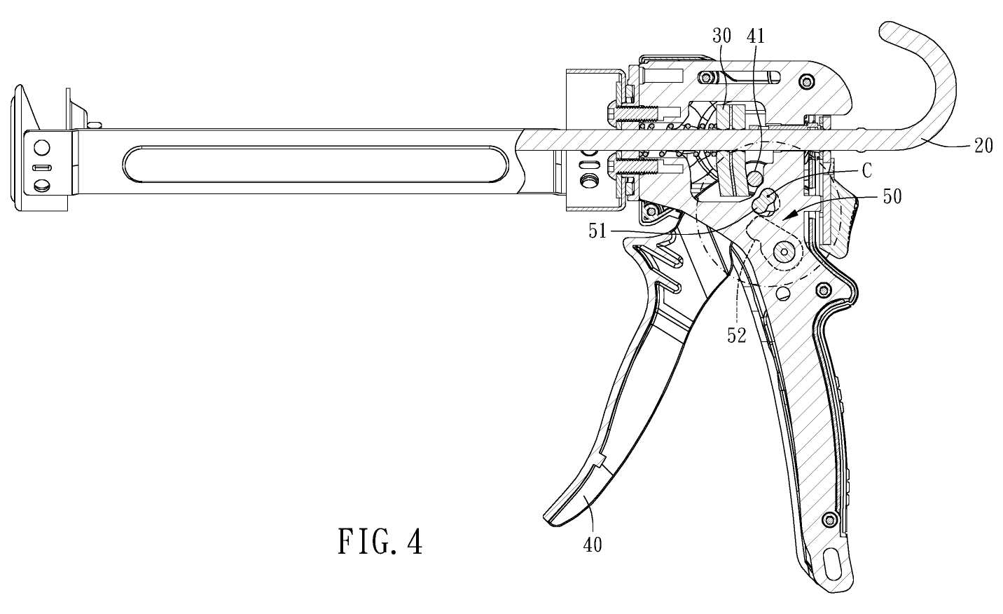

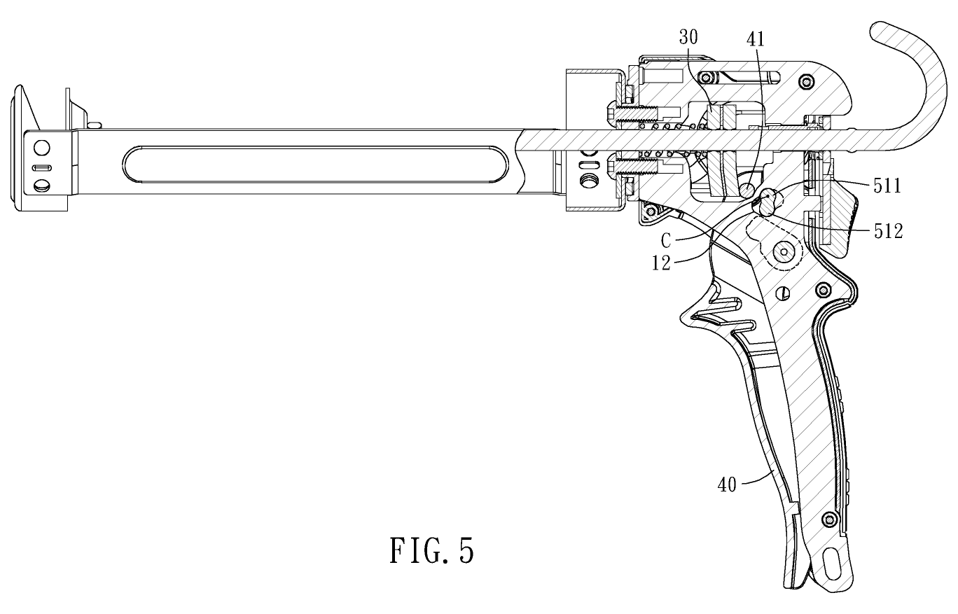

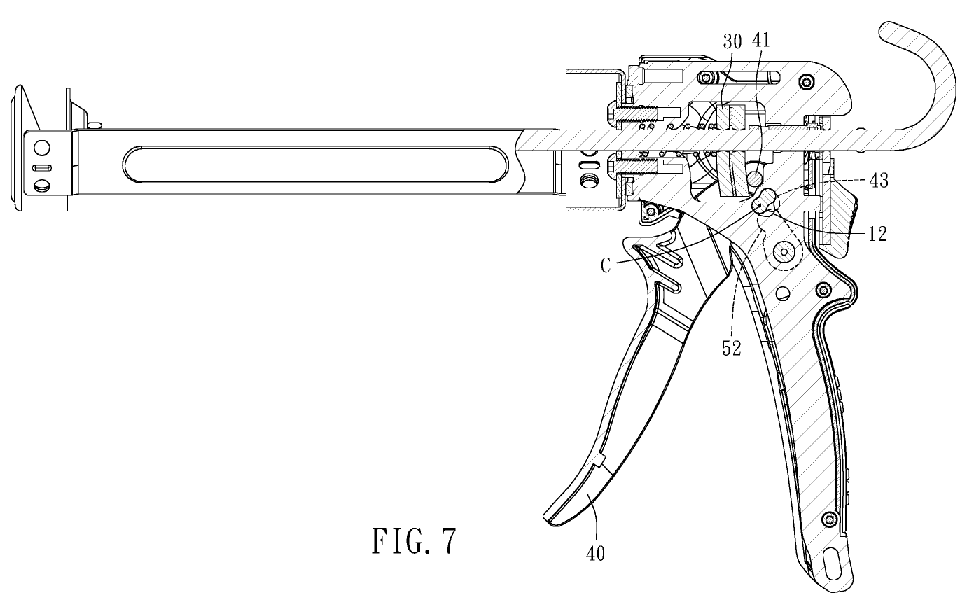

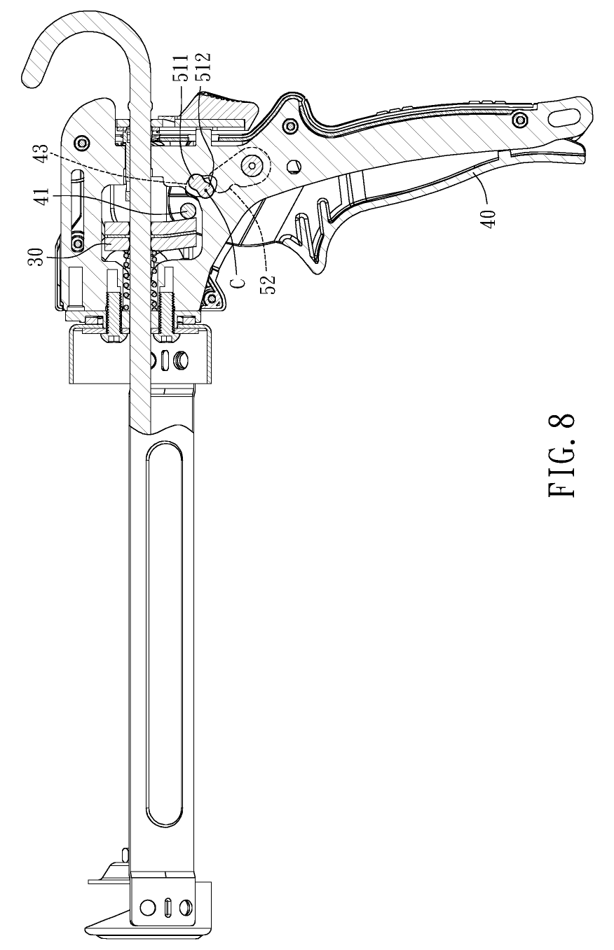

When the lever 40 is not actuated, a distance D1 between the abutting portion 41 and a center of the first pivot portion 511 is smaller than a distance D2 between the abutting portion 41 and a center of the second pivot portion 512. The first pivot groove 11 is located at a side of the at least one second swinging groove 43 relatively close to the abutting portion 41, and the at least one second pivot groove 42 is located at a side of the first swinging groove 12 relatively close to the abutting portion 41. In this embodiment, the abutting portion 41 is a push rod arranged on the lever 40, the distance D1 refers to a distance between a central axis of the push rod and a central axis of the first pivot portion 511, and the distance D2 refers to a distance between the central axis of the push rod and a central axis of the second pivot portion 512 (as shown in FIG. 6). In other embodiments, each said distance may be a distance between a portion of the abutting portion that contacts the driving member and the central axis of one of the first pivot portion and the second pivot portion. When the at least one restricting member 52 is free of interference with the pivoting member 51, the first pivot portion 511 serves as the pivot axis C, and the lever 40 is swingable about the first pivot portion 511, as shown in FIGS. 4 and 5, the abutting portion 41has a shorter swinging route. When the second pivot portion 512 serves as the pivot axis C, the at least one restricting member 52 is overlapped with the first swinging groove 12 in an open direction of the first swinging groove 12, and the at least one restricting member 52 is blocked with the second pivot portion 512 in an extension direction of the first swinging groove 12. Therefore, the second pivot portion 512 cannot be moved along the extension direction of the first swinging groove 12, as shown in FIGS. 7 and 8, and the abutting portion 41 has a longer swinging route.

The pivot mechanism 50 further includes an operating member 53 co-movably connected with the at least one restricting member 52. The gun body 10 includes a main body 13 and two housings 14 disposed on two opposite sides of the main body 13, the at least one restricting member 52 is disposed on the main body 13, and the operating member 53 is disposed on one of the two housings 14 and configured to be operated outwardly. In this embodiment, two said restricting members 52 are arranged on two opposite sides of the main body 13 for stable restriction; the operating member 53 is a dial knob, one of the two housings 14 has a concave groove 141 recessed thereon, and the dial knob is located within the concave groove 141 so that the dial knob is abuttable against a groove wall of the concave groove 141 for restriction. One of the two housings 14 preferably has two blocking projections 142 and two engaging recesses 143 engageable with the operating member 53, which allows the at least one restricting member 52 to be positioned in the first position or the second position without over-swinging. The main body 13 is made of metal, the two housings 14 are made of plastic, and at least a portion of the main body 13 is exposed out of the two housings 14 so as to have good structural strength, easy assembling, good appearance and be conductive to lightweight.

In summary, a position of the pivot axis C of the caulking gun 1 is changeable so that the distance that the abutting portion 41 pushes the driving member 30 and/ or the force that the abutting portion 41 exerted on the driving member 30 when the lever 40 is actuated is adjustable. Moreover, the first pivot groove 11 and the first swinging groove 12 are directly formed on the gun body 10, the at least one second pivot groove 42 and the at least one second swinging groove 43 are directly formed on the lever 40, and the pivoting member 51 has the first pivot portion 511 and the second pivot portion 512, which effetely simplifies a structure of the caulking gun 1. Therefore the caulking gun 1 is convenient to be manufactured and assembled, and the configurations as described above effectively reduce production costs and ensure smooth operation.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A caulking gun, including:
a gun body;
a push rod, movably disposed on the gun body;
a driving member, movably disposed on the gun body and driving the push rod to move;
a lever, swingably disposed on the gun body, including an abutting portion being abuttable against the driving member;
a pivot mechanism, including a pivoting member and at least one restricting member disposed on the gun body, the pivoting member connected with the lever and the gun body and including a first pivot portion and a second pivot portion;
wherein a position of the at least one restricting member is adjustable relative to the pivoting member so that one of the first pivot portion and the second pivot portion serves as a pivot axis, and the lever is pivotable about the pivot axis.

2. The caulking gun of claim 1, wherein the at least one restricting member is rotatably disposed on the gun body and movable relative to the pivoting member between a first position and a second position, when the at least one restricting member is in the first position, the at least one restricting member is free of interference with the pivoting member, the first pivot portion serves as the pivot axis about which the lever pivots; when the at least one restricting member is in the second position, the at least one restricting member is interfered with the pivoting member, and the second pivot portion serves as the pivot axis about which the lever pivots.

3. The caulking gun of claim 1, wherein the gun body has a first pivot groove and a first swinging groove communicated with each other, the first pivot portion is located within the first pivot groove, and the second pivot portion is movable within the first swinging groove.

4. The caulking gun of claim 3, wherein when the second pivot portion serves as the pivot axis, the at least one restricting member is overlapped with the first swinging groove in an open direction of the first swinging groove, and the at least one restricting member is blocked with the second pivot portion in an extension direction of the first swinging groove.

5. The caulking gun of claim 1, wherein the lever has at least one second pivot groove and at least one second swinging groove communicated with each other, the second pivot portion is located within the at least one second pivot groove, and the first pivot portion is movable within the at least one second swinging groove.

6. The caulking gun of claim 1, wherein the gun body has a first pivot groove and a first swinging groove communicated with each other, the lever has at least one second pivot groove and at least one second swinging groove communicated with each other, the first pivot groove is overlapped with the at least one second swinging groove, and the at least one second pivot groove is overlapped with the first swinging groove.

7. The caulking gun of claim 1, wherein when the lever is not actuated, a distance between the abutting portion and a center of the first pivot portion is smaller than a distance between the abutting portion and a center of the second pivot portion.

8. The caulking gun of claim 1, wherein the pivot mechanism further includes an operating member co-movably connected with the at least one restricting member, the gun body includes a main body and two housings disposed on two opposite sides of the main body, the at least one restricting member is disposed on the main body, and the operating member is disposed on one of the two housings and configured to be operated outwardly.

9. The caulking gun of claim 1, wherein the pivoting member is integrally formed in one piece, and a cross section of the pivoting member is formed in a shape of two partially overlapping circles.

10. The caulking gun of claim 4, wherein the at least one restricting member is rotatably disposed on the gun body and movable relative to the pivoting member between a first position and a second position, when the at least one restricting member is in the first position, the at least one restricting member is free of interference with the pivoting member, the first pivot portion serves as the pivot axis about which the lever pivots; when the at least one restricting member is in the second position, the at least one restricting member is interfered with the pivoting member, the second pivot portion serves as the pivot axis about which the lever pivots; the lever has at least one second pivot groove and at least one second swinging groove communicated with each other, the second pivot portion is located within the at least one second pivot groove, and the first pivot portion is movable within the at least one second swinging groove; the first pivot groove is overlapped with the at least one second swinging groove, and the at least one second pivot groove is overlapped with the first swinging groove; a radial profile of the first pivot groove corresponds to a radial profile of the first pivot portion, an extension length of the first swinging groove is greater than a diametrical dimension of the second pivot portion; a radial profile of each said second pivot groove corresponds to a radial profile of the second pivot portion, an extension length of each said second swinging groove is greater than a diametrical dimension of the first pivot portion; when the lever is not actuated, a distance between the abutting portion and a center of the first pivot portion is smaller than a distance between the abutting portion and a center of the second pivot portion, the first pivot groove is located at a side of the at least one second swinging groove relatively close to the abutting portion, the at least one second pivot groove is located at a side of the first swinging groove relatively close to the abutting portion; the pivot mechanism further includes an operating member co-movably connected with the at least one restricting member, the gun body includes a main body and two housings disposed on two opposite sides of the main body, the at least one restricting member is disposed on the main body, and the operating member is disposed on one of the two housings and configured to be operated outwardly; the operating member is a dial knob, one of the two housings has a concave groove recessed thereon, the dial knob is located within the concave groove; the main body is made of metal, the two housings are made of plastic, at least a portion of the main body is exposed out of the two housings; and the pivoting member is integrally formed in one piece, and a cross section of the pivoting member is formed in a shape of two partially overlapping circles.
